(19) United States
(12) Patent Application Publication
(10) Pub. No.: US 2013/0121690 A1
(43) Pub. Date: May 16, 2013

(54) NOVEL FIBER OPTIC TRAINING KIT

(71) Applicant: HITESH MEHTA, BANGALORE (IN)

(72) Inventor: HITESH MEHTA, BANGALORE (IN)

(21) Appl. No.: 13/371,499

(22) Filed: Feb. 13, 2012

(30) Foreign Application Priority Data
Aug. 18, 2009 (IN) 1964/CHE/2009
Aug. 28, 2009 (IN) PCT/IN2009/000493

(51) Int. Cl. H04B 10/08

(52) U.S. Cl. CPC H04B 10/0731
USPC 398/28

(57) ABSTRACT

The invention provides a fiber optic training kit for demonstrating and/or measuring fiber optic, fiber optic communication and fiber optic network characteristics comprises plurality of laser sources, plurality of PIN diode photo detectors. The fiber optic training kit includes a fiber Bragg grating block, a four channel multiplexing and de-multiplexing block, a fiber optic 50/50 coupler or splitter block, 980/15xx nm WDM coupler block, an erbium doped fiber optic amplifier block, a microcontroller, a function generator, a digital storage oscilloscope block, a variable optical attenuator block and a multi-meter arranged suitably in a pack with appropriate connections to power supply and a computer for the purpose of programming the microcontrollers, data recording and/or displaying the results.

### FIELD OF INVENTION

The present invention relates to a fiber optic training kit. More specifically, the invention is directed to a fiber optic training kit for providing demonstration and measurement, ranging from basic fiber optic to state-of-the-art technology fourth generation fiber optic communication, wherein user is exposed to advanced technologies like EDFA, WDM, OTDR, Eye pattern analysis, OADM and BER and additionally facilitates quantitative measurements.

### BACKGROUND OF THE INVENTION

Fiber optics is useful in numerous applications, for example, in transmission of signals in form of voice, video & data, as sensors, as amplifiers (erbium doped optical fiber), as lightguides in medical devices (endoscope) etc.

Fiber-optic communications permits signal transmission over longer distances and at higher bandwidths (data rates) than other forms of communications. Fiber optics has replaced metal wires because signals travel along them with less loss, and they are also immune to electromagnetic interference. Fiber optics is one major factor for the tremendous growth in the field of communication.

Accordingly, a great deal of research in industry and laboratory, for improving the fiber optic characteristics including attenuation loss, dispersion control, networking (WDM), fiber optic amplifiers etc., is going on world-wide. In many colleges and universities, especially in the engineering branch, various courses have been designed to teach the basic principles of fiber optics and fiber optic networking, both theoretically and experimentally.

Accordingly, there has been a huge academic research to improve students' conceptual understanding of fiber optics through the use of hands-on learning methods, in particular on the experimental part, as the field of fiber optics, fiber optic communication and networking may be well understood with help of laboratory experiments.

The various fiber optic characteristics are that may be demonstrated or measured, include fiber optic loss or attenuation at various wavelengths, and chromatic dispersion.

In the fiber optic network, various aspects of the network are required to be demonstrated for designing and during functioning of the fiber optic network, which include bit error rate [BER] analysis, eye pattern analysis, EDFA, OADM, WDM, and CWDM.

Instruments are known to be available commercially to measure and/or demonstrate various fiber optic characteristics including fiber optic loss, numerical aperture, mode field diameter, chromatic dispersion etc.

Further, for studying or demonstrating various characteristics of fiber optic communication and network, many instruments are designed till date, wherein using these instruments BER, eye pattern, EDFA, OADM, WDM and CWDM etc., may be easily demonstrated and studied.

One main disadvantage of these instruments for demonstration or measurement of fiber optic, fiber optic communication and network characteristics is that, using these instruments only one or at the most two characteristics may be demonstrated and/or measured, meaning that, it is not possible to demonstrate and/or measure all the fiber optic and fiber optic network characteristics using a single instrument.

Another disadvantage of these instruments for measurement or demonstration of fiber optic, fiber optic communication and network characteristics is that they are exorbitantly expensive. Though several instruments are capable of measuring and/or demonstrating the characteristics of the fiber optic, fiber optic communication and networks independently, the colleges and/or universities cannot afford to acquire all of these instruments for the research, due to exorbitantly high costs.

Further, it is highly unlikely to put up a testing instrument, wherein plurality of fiber optic, fiber optic communication and fiber optic network characteristics may be demonstrated and/or measured, in laboratory, since it is necessary to arrange, align and assemble multiple components to perform each experiment, which is highly time and energy consuming job, along with being tedious. It is sought-after to provide an alternative, wherein the time and energy needed to set-up the testing instrument is either reduced or eliminated totally, thereby allowing the students to focus on the concepts rather than on the particulars of the testing instrument. It is thereby desired that to have a single instrument or kit which is capable of demonstrating and/or measuring plurality of fiber optic, fiber optic communication and fiber optic networks characteristics.

Additionally, it is desired that the single kit or instrument which is capable of demonstrating and/or measuring plurality of fiber optic, fiber optic communication and fiber optic network characteristics, is economical.

Attempts have been made to design a single instrument or kit, wherein it is possible to demonstrate and/or measure plurality of fiber optic and fiber optic network characteristics.

Numerous fiber optic, fiber optic communication and fiber optic network training kits are commercially available, wherein it is possible to demonstrate and/or measure plurality of fiber optic, fiber optic communication and fiber optic networks characteristics.

However, it is observed that using the fiber optic, fiber optic communication and fiber optic network training kits mentioned above, it may be possible to perform few experiments, wherein few of the fiber optic, fiber optic communication and fiber optic network characteristics may be demonstrated and/or measured, but these training kits fails to provide demonstration and/or measurement of characteristics for fiber optic, fiber optic communication and fiber optic network including fiber optic loss, dispersion, WDM, TDM, EDFA, fiber Bragg grating, OADM, OTDR, BER, eye pattern analysis, power & rise time budgeting, analog & digital links and many more integrated into one single gadget.

Additionally, it is observed that none of the fiber optic and fiber optic network training kits known in the prior art provide the modern WDM experiments, especially CWDM or DWDM experiments, which is the backbone of present day fiber optic communication.

Thus, the existing fiber optic and fiber optic network training kits are not capable of providing all the above-mentioned experiments.

It is further observed that the number of experiments cannot be extended, that is, new experiments cannot be added or additional fiber optic, fiber optic communication and fiber optic network characteristics cannot be demonstrated and/or measured using these kits, thereby limiting the number of experiments to a few specific ones. It is desired that the training kit must be flexible enough so that further components or hardware and software may be added so as to have scope for extending the number of experiments or demonstrating and/or measuring fiber optic, fiber optic communication and fiber optic network characteristics in addition to the specified ones.

It is observed that for the training kits provided in the prior art, the devices such as digital oscilloscope, function generator, power meter etc., are to be provided externally, thus increasing the total cost, the size and the complexity of the training kits for performing the experiments. It is thereby desired to have a training kit without having separate devices including digital oscilloscope, function generator, power meter etc., for performing the experiments, meaning that, it should be a standalone solution.

Thus, there exists a need for a training kit for fiber optic, fiber optic communication and fiber optic network, wherein at least all the above-mentioned experiments may be performed, along with being economical, less tedious, less time and human energy consuming, compatible for extending or adding additional experiments or fiber optic, fiber optic communication and fiber optic network characteristics. Additionally, it is required to have a training kit wherein the devices needed for the performing these experiments including digital oscilloscope, function generator, power meter etc., are incorporated therein.

### OBJECTS OF THE INVENTION

An object of the invention is to provide a fiber optic training kit.

Another object of the invention is to provide a fiber optic, fiber optic communication and fiber optic network training kit.

Still another object of the invention is to provide a fiber optic, fiber optic communication and fiber optic network training kit wherein at least the above-mentioned experiments may be performed.

Yet another object of the invention is to provide a fiber optic, fiber optic communication and fiber optic network training kit wherein, using this kit the CWDM experiment may be performed.

Another object is to provide a fiber optic, fiber optic communication and fiber optic network training kit which is economical.

Another object is to provide a fiber optic, fiber optic communication and fiber optic network training kit, wherein it is possible to extend the number of experiments or add or perform experiments or demonstrate and/or measure fiber optic, fiber optic communication and fiber optic network characteristics other than specified.

Another object is to provide a fiber optic, fiber optic communication and fiber optic network training kit, wherein it is possible to demonstrate and/or measure the characteristics of fiber optic, fiber optic communication and fiber optic network, including fiber optic loss, dispersion, WDM, TDM, EDFA, fiber Bragg grating, OADM, OTDR, BER, eye pattern analysis, power & rise time budgeting, analog & digital links and many more integrated into one single gadget.

Another object is to provide a fiber optic, fiber optic communication and fiber optic network training kit, wherein no separate devices are required to be externally connected.

Another object is to provide a fiber optic, fiber optic communication and fiber optic network training kit, wherein all the fiber optic and fiber optic network characteristics may be demonstrated and/or measured using the single training kit.

The other objects and advantages of the present invention will be apparent from the following description when read in conjunction with the accompanying drawings which are incorporated for illustration of preferred embodiments of the present invention and are not intended to limit the scope thereof.

### SUMMARY OF THE INVENTION

Accordingly the invention provides a fiber optic training kit for providing exposure ranging from basic fiber optic to state-of-the-art technology fourth generation fiber optic communication, wherein user is exposed to advanced technologies like EDFA, WDM, OTDR, Eye pattern analysis, OADM and BER and additionally facilitates quantitative measurements.

The various exemplary embodiments of the present invention described herein solves the problems of the prior art and attains the desired objectives with a single fiber optic training kit demonstrating and/or measuring fiber optic, fiber optic communication and fiber optic network characteristics, wherein the fiber optic training kit comprises plurality of laser sources, plurality of PIN diode photodetectors.

The fiber optic training kit comprise various optical blocks including a fiber Bragg grating block, a four channel multiplexing and de-multiplexing block, a fiber optic 50/50 coupler or splitter block, a 980/15xx nm WDM coupler block, an erbium doped fiber optic amplifier block, a microcontroller circuit, a function generator, a digital storage oscilloscope block, a variable optical attenuator block and a multi-meter arranged suitably in a pack with appropriate connections to power supply and a computer for the purpose of programming the microcontrollers, data recording and/or displaying the results.

Additionally, the personal computer and the microcontrollers are suitably programmed for performing various calculations and other details required for demonstrating and/or measuring the fiber optic and fiber optic network characteristics.

Using the fiber optic training kit, numerous experiments related to fiber optic, fiber optic communication and fiber optic networks may be performed by suitably linking one or more laser sources and photodetectors in combination with one or more blocks of WDM, EDFA etc., provided therein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE FIGURES

The detailed description is set forth with reference to the accompanying figures. In the figures, the left-most digit(s) of a reference number identifies the FIGURE in which the reference number first appears. The use of the same reference numbers in different figures indicates similar or identical items.

As herein the word “characteristic” is used to mean various optical parameters of fiber optic such as attenuation and dispersion and also various aspects of fiber optic communication and fiber optic network such as WDM, EDFA etc.

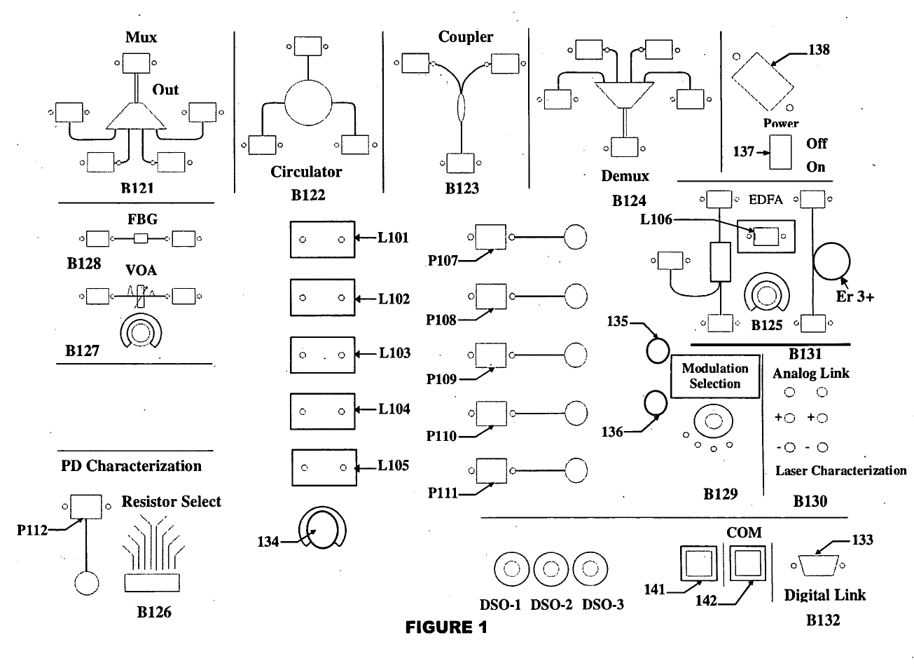

FIG. 1 illustrates one embodiment of the invention having components of the fiber optic training kit imbedded into a pack [a metal cased box] so as to facilitate various experiments related to fiber optic and fiber optic network characteristics.

### DETAILED DESCRIPTION OF THE INVENTION

The details disclosed below are provided to describe the following embodiments in a manner sufficient to enable a person skilled in the relevant art to make and use the disclosed embodiments. Several of the details described below, however, may not be necessary to practice certain embodiments of the invention. Additionally, the invention can include other embodiments that are within the scope of the claims but are not described in detail with respect to the following description. In the following section, an exemplary environment that is suitable for practicing various implementations is described.

This disclosure is directed to a fiber optic training kit. More particularly, the disclosure is directed to a fiber optic training kit for providing exposure and demonstration, ranging from basic fiber optic to state-of-the-art technology fourth generation fiber optic communication, wherein user is exposed to advanced technologies like EDFA, WDM, OTDR, Eye pattern analysis, OADM and BER and additionally makes possible quantitative measurements.

FIG. 1 illustrates an embodiment of the invention having components of the fiber optic training kit embedded into a pack 100 [a metal cased box] so as to facilitate various experiments related to fiber optic, fiber optic communication and fiber optic network characteristics. In the embodiment illustrated by FIG. 1, the laser sources [indicated by L101, L102, L103, L104 and L105] and the PIN diode photodetectors [indicated by P107, P108, P109, P110 and P111] are positioned at the center of the pack, wherein the lasers and detectors are placed opposite to each other in a combination of source-detector as L101-P107, L102-P108, L103-P109, L104-P110 and L105-P111. [In FIG. 1, the rectangular blocks indicate fiber optic adaptors, small circles indicate means of attaching the adaptors onto the pack 100 (using screws) unless and otherwise specified].

An additional laser source L106 is provided for amplification purpose with a wavelength of about 980 nm. It is referred to as 980 nm PUMP because as it amplifies the input signal.

An additional photodetector P112 is an InGaAs photodetector provided for rise time measurements in the wavelength range of 1000 nm to 1700 nm.

The fiber optic training kit, in addition to the laser sources and photodetectors, includes a multiplexing block [MUX] B121, a circulator B122, a coupler block B123, a De-multiplexing block [DEMUX] B124, an EDFA block B125, photodetector characterization device B126, a variable optical attenuator [VOA] B127 and a fiber Bragg grating block [FBG] B128.

The fiber optic training kit includes a modulation selection block B129, a laser characterization block B130, an analog link block B131, a digital link block P132, a socket for plugging power cord P133, two USB sockets USB 141 and USB 142, a digital oscilloscope [DSO] block with three BNC connectors [indicated by DSO-1, DSO-2 and DSO-3] are provided along the periphery of the pack 100.

Further, the training kit pack 100 includes a power control rotating knob 134 for increasing 1550 nm laser power. This is useful for analog variation of 1550 nm laser power with great precision.

In a preferred embodiment the lasers L101, L102, L103 and L104 are the distributed feedback diode lasers [DFB].

In a more preferred embodiment the lasers L101, L102, L103 and L104 are the distributed feedback diode lasers [DFB] with wavelengths in the C-band region, which extends from about 1510 nm to about 1570 nm.

In the most preferred embodiment the lasers L101, L102, L103 and L104 are the distributed feedback diode lasers [DFB] with wavelengths in the C-band region, wherein L101 has a wavelength of about 1510 nm, L102 has a wavelength of about 1530 nm, L103 has a wavelength of about 1550 nm and L104 has a wavelength of about 1570 nm.

In one embodiment the L105 is a laser in visible region with a wavelength of about 660 nm.

In a preferred embodiment the PIN diode photodetectors P107, P108, P109 and P110 are InGaAs PIN diode high speed detectors.

In the most preferred embodiment the PIN diode photodetectors P107, P108, P109 and P110 are InGaAs PIN diode high speed photodetectors capable of detecting infrared wavelengths from about 1500 nm to about 1570 nm.

In one embodiment the P111 is also a Silicon diode high speed photodetector capable of detecting light in the visible region, particularly at around 660 nm.

In one embodiment the plurality of lasers and the plurality of detectors are controlled using an electronic programmable driver, which is actually an ARM-7 microcontroller, thereby enabling the precise controls over the lasers in particular.

In one embodiment the multiplexing block B121 comprises an optical wavelength division multiplexer which accepts four different wavelengths at its inputs and combines them to appear on its output. The optical wavelength division multiplexer is a bidirectional device, in which light is reciprocal and hence may be used as a Demux too. It has in all five ports viz, four optical input ports 1510 nm, 1530 nm, 1550 nm, 1570 nm, and one output port wherein the combined signal of all the four signals combined on its four input port appears. [The input as well as output ports are indicated in FIG. 1 by rectangular boxes].

In one embodiment the circulator block B122 comprises a three-port optical circulator, characterized in that light launched into port 1 is be passed to port 2; conversely, light launched in port 2, instead of appearing at port 1, appear at port 3, and thereby light in it is non-reciprocal unlike in the other optical devices.

In one embodiment the 50-50 coupler/splitter block B123 comprises a three port device, wherein the light fed at COM port is split equally and delivered at two different ports labeled as “50” and “50”, meaning that each port receives 50% of the original light.

In another embodiment the 50-50 coupler/splitter block B123 comprising the three port device may be used as a coupler, wherein the light fed at two 50-50 ports using two different sources are combined and appear at COM port.

In one embodiment the De-multiplexing block B124 comprises an optical wavelength de-multiplexer which accepts one optical input, consisting of different wavelengths combined together at it's “IN” port and separates out the signals of different wavelengths at its output ports. The optical wavelength division de-multiplexer is a bidirectional device, in which light is reciprocal and hence may be used as a MUX. It has in all five ports viz, one input port of DEMUX, wherein the input signal is launched, and four output ports wherein the four signals separated appear.

In one embodiment the Erbium Doped Fiber Amplifier Block [EDFA] B125 comprises an erbium [Er³⁺] doped optical fiber, a bidirectional two port device, wherein signal launched at any one of the two ports is amplified. In particular, the present invention the device acts as an amplifying medium for C-band signals.

In one embodiment the EDFA block B125 further comprises a laser with output optical signal at 980 nm wavelength and with maximum power less than or equal to 100 mW. This is provided for giving the necessary optical power for the amplifying medium to serve its purpose.

In one embodiment the EDFA block B125 comprises a WDM coupler, which is a bidirectional three port device, wherein one output port is COM at which the output combined signal appear and the other input ports for launching two input signals to be combined. In one embodiment the input and output ports are interchangeable.

In one embodiment the PD characterization block B126 comprises a DIP switch, wherein value of the resistor across the photo detector may be selected to be put in the circuit.

In one preferred embodiment, the DIP switch includes eight small switches and 7 of them represent resistors. The eighth one is for selecting the photoconductive or photovoltaic mode of the photodiode for its characterization. A particular value of resistor may be selected by pushing the small switch.

In one embodiment the variable optical attenuator [VOA] block B127 comprises a variable optical attenuator, which is a bidirectional, two port device, one input port and the other output port. The VOA is characterized in that an optical signal fed at one of the port appears at the other port, attenuated by some amount. The amount of attenuation of the signal may be controlled by using the knob provided therein.

In one embodiment the fiber Bragg grating [FBG] block B128 comprises a fiber Bragg grating which is a bidirectional, two port device, one input port and one output port. An optical signal with multiple wavelengths is launched to any port of this device, it reflects single wavelength of interest back, whereas rest of the wavelengths are passed to other port.

In one embodiment the modulation selection block B129 comprises a rotary switch using which the power and modulation of 1550 nm may be selected/controlled in four different modes.

In the one embodiment the switch is in the “digital” mode, the 1550 nm laser power is controlled by internal digital control, that is, by software setting.

In another embodiment the switch is in “manual” mode, the 1550 nm power is controlled by 1550 nm power knob 134 and the internal digital control has no effect on laser power.

In still another embodiment the switch is in “audio” mode and the 1550 nm laser accepts audio input fed at the MIC input. It is AC coupled and the DC level of the signal fed may be adjusted internally by rotating the “1550 nm power control knob” 134.

In yet another embodiment the switch is in External mode and the 1550 nm laser accepts analog modulation input fed at the “EXT IN” 136 BNC connector. None of the power controls for the 1550 nm laser are active.

In one embodiment the laser characterization block 130 comprises plurality of test points capable of accepting multi-meter probes, wherein voltage measured between “+” and “−” points is proportional to the current flowing through the 1550 nm laser diode.

In one embodiment all the hardware, that is, the laser sources, photodetectors, the MUX block, the DEMUX block, the circulator block, the coupler block, the EDFA block, the modulation selection block, the analog link block, the digital link block, the photodiode characterization block, the VOA block, the FBG block, the DSO block, the power meter etc., are human controlled for carrying out specific tasks required for the experiments.

In one embodiment the all the hardware that is the laser sources, photodetectors, the MUX block, the DEMUX block, the circulator block, the coupler block, the EDFA block, the modulation selection block, the analog link block, the digital link block, the photodiode characterization block, the VOA block, the FBG block, the DSO block, the power meter etc., are controlled by via a computer, the computer being programmed suitably for carrying out specific tasks required for the experiments.

Numerous experiments related to fiber optic, fiber optic communication and fiber optic network may be performed using the training kit of the invention. The following are a few examples that may be performed using the training kit, wherein it is shown how to combine plurality of components to perform the experiments, which demonstrate the enablement of the novel fiber optic training kit of the present invention:

### Experiment 1

### Measurement of Attenuation of an Optical Fiber

The attenuation of optical fiber may be determined by using the method referred to as the ‘cut back method’. In this technique, light is launched into the optical fiber and the power exiting a length L of the fiber is measured. Then without disturbing the input, the fiber is cut near the input end (about 1 m from the input end) and the power exiting is again measured. Knowing the length of the fiber cut in this process we can estimate the attenuation coefficient of the fiber.

In order to perform this experiment, four C band lasers, one visible laser, one InGaAs photodetector, one Si photodetector and 3 spools of fiber optic are required. In order to measure the attenuation of the optical fiber, the power from 1550 nm laser is coupled to anyone of the InGaAs photodetectors [PD1-PD4] using a fiber patch cord and the reading for the output power P₁ is noted. Thereafter the patch cord is disconnected from the detector, it is connected to the given fiber spool of known length L. The other end (output) of the fiber spool is connected to the same photodetector and the optical power from the spool is recorded as P₂. The experiment is repeated for different lengths of fiber and various wavelengths including other C-band wavelengths and 660 nm. It may be noted that for 660 nm laser, the photodiode used should be the Si Photodiode denoted as PD5.

Using the formula total attenuation (A), in dB=10 log(P₁/P₂), where P₁ and P₂ are input and output powers measured as described above. This attenuation (A) when divided by length L (km) of the fiber gives the attenuation coefficient in dB/km.

Thus, it is possible to demonstrate and measure the attenuation coefficient of the optical fiber at wavelengths of interest using the novel fiber optic training kit of the present invention.

### Experiment 2

### Dispersion in Optical Fiber

The dispersion in optical fiber which is actually broadening of the pulse in time as it passes through the fiber. This may be caused due to many different mechanisms well-known in theory.

The components of the fiber optic training kit used for demonstration and measurement of the optical fiber dispersion are a 1550 nm Laser, a 660 nm Visible Laser, a InGaAs photodetector, a Silicon Photodetector, a DSO, Fiber spools, a 50/50 Coupler, a 980/15xx coupler

In order to demonstrate and measure the dispersion characteristic of the optical fiber, the 660 nm and 1550 nm lasers are switched on. Using patch cords light from the 660 nm laser and the 1550 nm laser is multiplexed through a 3 dB coupler and the combined beam is sent to the 980/15xx coupler to separate out 660 nm and 1550 nm wavelengths. The separated wavelengths, 660 nm and 1550 nm laser light, are respectively connected to the silicon and the InGaAs photodetectors which are in turn connected to Channels 1 and 2 of DSO. As both lasers deliver modulated output at the same pulse rate, the delay between the starting points of the two laser pulses can be measured on the DSO screen. The patch cord connecting 980/15xx coupler and 50/50 coupler is then replaced with a spool of known fiber length and the delay between the two laser pulses is again measured on the DSO screen. Spools of different lengths of the fiber are connected and the delay between the arrival of visible (660 nm) and IR light (1550 nm) at the detector is measured as a function of the fiber length. From the above measurements the delay between 660 nm and 1550 nm pulses per km can be determined which will be roughly same as the dispersion produced by a broad light source of 900 nm spectral width (difference between 1550 nm and 660 nm). The experimental result obtained in the present experiment is validated with the theoretical results obtained using the theory provided in the kit's manual.

### Experiment 3

### WDM Mux and Demux Characterization

Using the novel training kit of the invention it is possible to demonstrate and measure characteristics of WDM Mux and Demux devices, such as insertion loss and loss uniformity. Additionally, it also possible to determine the optical cross talk in adjacent and non-adjacent channels of WDM Demux for various wavelengths.

The components utilized for the experiment are four C-Band Lasers, 4 channel WDM Mux, 4 channel WDM Demux, a InGaAs Photodetector, and optical power meter.

In accordance with the invention, for measurement of the insertion loss the optical power from one of the C-Band Lasers, say 1510 nm laser, is taken out using a patch cord and measured using one of the InGaAs photodetectors. The laser power is adjusted for operation below detector saturation (4V on DSO) and is measured as P₁. The patch cord end connected to the detector is removed and connected to the 1510 nm channel of Mux. The optical power from the COM port of Mux is fed to the same photodetector, PD1 using another patchcord and the optical power is measured as P₂. The formula

Insertion loss, IL(dB)=−10 log(P₂/P₁)

is used to find out the insertion loss for that channel.

In order to measure the optical cross talk in the adjacent and non-adjacent channels of WDM Demux for various wavelengths, one of the C band lasers, say 1550 nm laser is connected to COM port of Demux using a patchcord and its 1550 nm output channel is connected to the optical power meter using another patchcord. The optical power is measured as Pi. Similarly the optical powers, Pᵢ coming at other ports (1510, 1530 and 1570) are also measured. The formula

Cross talk (dB)=10 log(Pⱼ/Pᵢ)

is used to determine the signal loss due to optical cross talk.

Thus, using the novel fiber optic training kit of the invention it is possible to demonstrate and measure various characteristic of WDM such as insertion loss and cross talk.

### Experiment 4

The reflectivity of the fiber Bragg grating at various wavelengths, its wavelength selectivity may be studied using the novel fiber optic training kit of the invention. Additionally, the insertion loss and cross talk of a S-port circulator at various wavelengths can be measured.

To demonstrate the reflectivity and selectivity of the FBG and measure the insertion loss and cross talk of the 3-port circulator at various wavelengths, a FBG, a Fiber optic Circulator, four C-band lasers, one InGaAs photodetector are required.

In accordance with the present invention one of the C-band lasers is connected to an InGaAs photodetector PD3 using a patchcord and the laser power is measured as P₁. The patchcord end is disconnected from the photodetector and it is connected to one end of the given FBG. Another patchcord is connected from the other end of the FBG to the photodetector PD3 and the power measured is P₂. Reflectivity may be calculated using the formula

Reflectivity of FBG=[(P₁−P₂)/(P₁)]

The reflectivity measurement is repeated for other wavelengths and the FBG reflectivity for each of the wavelength is calculated. From these measurements the FBG peak reflection wavelength is determined.

For determining the insertion loss and cross-talk of a 3-port circulator, one of the C-band Lasers, is connected to an InGaAs photodetector, using a patchcord and the laser power is measured as P₁. The patchcord end is disconnected from the photodetector and it is connected to Port 1 of the given Optical Circulator. Another patchcord is used to connect Port 2 of Circulator to the same photodetector, PD3 and the power measured is P₂. Patch cord at Port 2 is disconnected and then connected to Port 3 for determination of optical power, P₃. The formulas

Insertion loss of circulator (dB)=−10 log(P₂/P₁) and

Cross talk in circulator (dB)=10 log(P₃/P₂)

are used to determine the insertion loss and cross talk in the circulator.

Thus, using the fiber optic training kit of the present invention it is possible to demonstrate the characteristics of the FBG and the circulator as indicated above.

### Experiment 5

### Time Division Multiplexing of Digital Signals

Using the fiber optic training kit of the present invention the concept of time division multiplexing of digital signal may be demonstrated and same may be observed on the screen of the inbuilt digital storage oscilloscope [DSO]. Additionally, it is possible to determine another characteristic of TDM, wherein the minimum power of laser for faithful reproduction of time division multiplexed signals may be determined.

The components required to perform the experiment are 1550 nm laser, InGaAs photodetector (PD3), VOA, DSO and patch chords.

Using patch cords, the 1550 nm laser is connected to the photodetector PD3 via VOA and its output is connected to DSO using BNC cable. The VOA is set to be in the minimum attenuation position. The 1550 nm laser is switched on with maximum power and maximum frequency. Data are entered on the four channels of LIGHT RUNNER software. The multiplexed data bit stream appears on the LIGHT RUNNER and DSO screens. Now the laser power is reduced to lower values (90%, 80%, etc) and the experiment is repeated, till the laser power is insufficient (say at 40%) to reproduce the bit stream on LIGHT RUNNER screen (it may still be identifiable on the DSO screen). Now the laser power is fixed at the next higher power level (50%) where one can retrieve the sent data stream. The VOA knob is rotated clockwise till its attenuation causes the loss of data on LIGHT RUNNER screen. After disconnecting the patch cord from PD3, it is connected to the given optical power meter and the power is measured. After setting the laser at a reasonable power level (50%) and frequency (100 kHz), data bits are entered on the four channels and their ASCII equivalent appears on the DSO screen. The ASCII equivalent to each data bit entered is noted. The experiment may be then repeated for various frequencies.

Thus, using the fiber optic training kit of the present invention the concept of time division multiplexing of digital signal can be demonstrated and same may be observed on the screen of the inbuilt digital storage oscilloscope [DSO]. Additionally the minimum power of laser for faithful reproduction of time division multiplexed signals may be determined.

### Experiment 6

### Optical Time Domain Reflectometer

The length of a given fiber sample may be determined using the fiber optic training kit of the present invention. The effect of pulse width on spatial resolution may also be studied.

An Optical Time Domain Reflectometer (OTDR) is a device that enables one to measure the losses in an optical fiber, identify points of breaks in an optical fiber link or change of fiber types in a system, estimate the splice losses at joints, etc. OTDR works on the principle that when a light pulse is launched into an optical fiber, a small fraction of it gets scattered in all directions due to Rayleigh scattering and a part of the scattered light travels back to the input end of the fiber. If this light is detected then it gives us an estimate of the variation of power along the length of the fiber and information on the attenuation through the fiber. Since Rayleigh scattering is very weak (≈0.01%) and only a fraction of the scattered light is coupled back into the fiber, one requires sophisticated instrumentation to measure the back-scattered light.

In order to build an optical time domain reflectometer the components namely, an InGaAs photodetector, a DSO, an optical circulator, and a C band laser are used.

For determination of the sample fiber length the 1550 nm laser is connected to the Port 1 of the optical circulator using a patch cord. The pulse width of 1550 nm laser light is selected as 1 μs. Port 3 is connected to photodetector, PD3 using another patch cord. The CLK/TRIG 135 connector on the LIGHT RUNNER Front Panel, which has the trigger pulse to the laser, is connected to Channel 1 of DSO using a BNC cable after setting the trigger source to Channel 1 in DSO software. PD3 electrical output is connected to Channel 2 of DSO through a BNC cable which displays the light reflected from Port 2 of the circulator due to the refractive index mismatch between core of the fiber and the surrounding medium (air). It can be observed that pulses at Channel 1 and Channel 2 are nearly aligned vertically which means that they occur almost simultaneously. A fiber spool is connected to Port 2 of the circulator. It can be observed that the reflected light pulse from the fiber spool end which is appearing at Channel 2 is shifted in time with respect to the pulse at Channel 1. This shift in time of the detected pulse with respect to the trigger pulse for the laser is measured. This corresponds to the time delay for light to traverse twice the length of the fiber. Knowing the speed of light in the fiber having a core refractive index 1.46, the total length covered by the light pulse (twice the length of the fiber) can be calculated. The experiment is repeated for various combinations of fiber spools to determine their lengths and attenuation. The pulse width of the light pulse is changed to 2 μs, 5 μs and 10 μs and the whole set of experiment is repeated.

Thus, using the fiber optic training kit of the present invention the length of a given fiber sample may be determined and the effect of pulse width on spatial resolution may also be demonstrated.

Thus, using the novel fiber optic training kit of the present invention with the components provided therein, it is possible to demonstrate and/or measure fiber optic, fiber optic communication and fiber optic network characteristics.

It is to be noted that it is possible to incorporate additional components and/or devices, such as the number of lasers and detectors in the present novel fiber optic training kit is limit to six each, may be increased to any desired number and thereby extend the number of experiments and characteristics to be demonstrated and/or measured for the fiber optic, fiber optic communication and fiber optic network.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A fiber optic training kit, comprising:
a plurality of laser sources and plurality of photodetectors;
a plurality of optical blocks, wherein each optical block comprises at least one optical component;
a plurality of electrical and electronic devices;
means for connecting said plurality of laser sources, said plurality of photodetectors and said plurality of optical blocks to form a setup for performing at least one experiment, wherein one or more characteristics of fiber optic, fiber optic communication and fiber optic network are demonstrated and/or measured; and
means for demonstrating, displaying and/or measuring the output of said experiment.

2. The fiber optic training kit of claim 1, wherein at least one of said plurality of laser sources is distributed feedback diode laser having wavelengths in the C-band region, extending from about 1510 nm to about 1570 nm, particularly with wavelengths 1510 nm, 1530 nm, 1550 nm and 1570 nm respectively.

3. The fiber optic training kit of claim 1, wherein at least one said laser source has a wavelength in visible region with a wavelength of about 660 nm, and at least one said lease source is provided at a wavelength of about 980 nm.

4. The fiber optic training kit of claim 1, wherein at least one of said plurality of photodetectors is InGaAs PIN diode high speed detectors are capable of detecting infrared wavelengths from about 1510 nm to about 1570 nm

5. The fiber optic training kit of claim 1, wherein at least one said photodetector is silicon diode high speed photodetector capable of detecting light in the visible region at around 660 nm.

6. The fiber optic training kit of claim 1, wherein the plurality of lasers and the plurality of detectors are controlled using an electronic programmable driver.

7. The fiber optic training kit of claim 2, wherein said plurality of lasers and said plurality of photodetectors are positioned opposite to each other.

8. The fiber optic training kit of claim 1, wherein said plurality of optical blocks comprise at least one multiplexing block, wherein said multiplexing block comprises a optical wavelength division multiplexer, wherein said each optical block of said plurality of blocks comprises a plurality of optical components.

9. The fiber optic training kit of claim 8, wherein said optical components are selected from a group consisting of FBG, multiplexer, de-multiplexer, coupler, circulator, variable optical attenuator and erbium doped optical fiber.

10. The fiber optic training kit of claim 8, wherein said optical wavelength division multiplexer is a bidirectional four optical wavelength division multiplexer with four input ports capable of accepting 1510 nm, 1530 nm, 1550 nm and 1570 nm wavelengths and one output port.

11. The fiber optic training kit of claim 1, wherein said plurality of optical blocks comprise at least one circulator block, wherein the circulator block comprises a multi-port optical circulator, wherein the multi-port optical circulator is a three-port optical circulator.

12. The fiber optic training kit of claim 1, wherein said plurality of optical blocks comprises at least a coupler/splitter block, wherein said coupler/splitter block comprises a bidirectional, three port 50-50 coupler/splitter having two input ports and one output port.

13. The fiber optic training kit of claim 1, wherein said plurality of optical blocks comprises at least a de-multiplexing block, wherein said de-multiplexing block comprises a four optical wavelength de-multiplexer bidirectional device.

14. The fiber optic training kit of claim 1, wherein said plurality of optical blocks comprises at least one erbium doped fiber amplifier block, wherein said erbium doped optical fiber block comprises a two port bidirectional erbium [Er³⁺] doped optical fiber capable of amplifying C-band signals, wherein said erbium doped optical fiber amplifier block comprises a laser a wavelength of about 980 nm.

15. The fiber optic training kit of claim 14, wherein said erbium doped optical fiber amplifier block comprises a bidirectional three port 980/15xx WDM coupler with one output port and two input ports.

16. The fiber optic training kit of claim 1, wherein said plurality of optical blocks comprise at least one PD characterization block, wherein said PD characterization block comprises a DIP switch, wherein said DIP switch comprises eight small switches with 7 of them for resistors and eighth for selecting the photoconductive or photovoltaic mode of the photodiode.

17. The fiber optic training kit of claim 1, wherein said plurality of optical blocks comprise at least one variable optical attenuator block and at least one fiber Bragg grating block, wherein said variable optical attenuation block comprises a two port bidirectional variable optical attenuator, wherein said fiber Bragg grating block comprises a bidirectional two port fiber Bragg grating.

18. The fiber optic training kit of claim 1, wherein said electrical and electronic devices are selected from a group consisting of one or more ON-OFF switches, one or more sockets for accepting power cord for power, one or more USB sockets, one or more BNC connectors, electrical power cords and microprocessor controllers.

19. The fiber optic training kit of claim 1, wherein said means of connecting said plurality of laser sources, said plurality of PIN diode photodetectors and said plurality of optical blocks to form a setup for performing at least one experiment are optical patch cords and optical fibers.

20. The fiber optic training kit of claim 1, wherein said means of demonstrating, displaying and/or measuring output of said experiment are selected from group consisting of digital storage oscilloscope, LCD monitor, power meter and multi-meter.
